(19) United States
(12) Patent Application Publication
(10) Pub. No.: US 2004/0031251 A1
(43) Pub. Date: Feb. 19, 2004

(54) Multi-stage filter assembly for gaseous, moist media

(76) Inventor: Gunter Priess, Krefeld (DE)

Correspondence Address: Proskauer Rose, 1585 Broadway, New York, NY, 10036, US

(21) Appl. No.: 10/258,205

(22) PCT Filed: Apr. 12, 2001
(86) PCT No.: PCT/EP01/04231

(30) Foreign Application Priority Data
Apr. 22, 2000 (DE) 100 20 108.3

(51) Int. Cl. B01D 46/00

(52) U.S. Cl. 55/485

(57) ABSTRACT

The invention relates to a multistage filter installation for gaseous media laden with water and/or oil. The stages (1, 2, 3) of the multistage filter installation contain filter aids where water and/or oil separate as a result of the coalescence effect, and the individual stages (1-3) of the filter installation have a greater separating capacity form one stage to another in the direction of flow of the media. The pore size of the filter aid becomes smaller from one stage to another and/or the layer thickness of the filter aid becomes larger, and the flow cross-section becomes larger such that the flow rate becomes lower from one stage to another without increase in pressure.

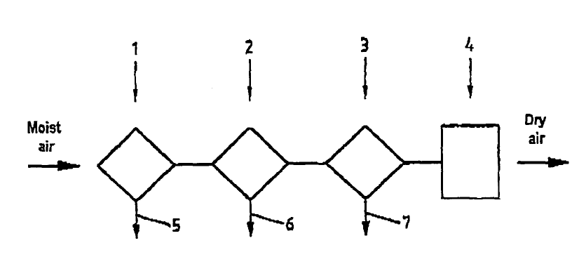

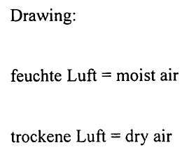

The invention relates to a multi-stage filter installation for gaseous media charged with water and/or oil, the stages of which contain filtering means on which water and/or oil collect due to the coalescence effect.

Filter installations of this type are known in practice. They are used to clean e.g. air by filtering out moisture particles and possibly other foreign materials. The moisture removed from the gaseous medium partially collects on the filtering means in form of droplets due to the coalescence effect and can be removed at every stage over a condensate run-off. Another share of the moisture, but mainly the other foreign solid particles, are collected by the filtering means. As soon as the filtering characteristics of the filtering means are exhausted they must be replaced by new filtering means.

In the known multi-stage filter installation the individual stages are essentially identical in structure. In particular, the gaseous media to be filtered flow at constant velocity through the different stages.

It is the object of the present invention to create a multi-stage filter installation the effectiveness of which is improved over that of conventional filter installations.

This object is attained through the invention in that the different stages of the filter installation present a greater collecting capacity from stage to stage, in the direction of flow, so that the flow velocity is reduced from stage to stage without any increase in pressure.

Although the different stages present essentially an identical structure as before, the lowering of the flow velocity of the media to be filtered results in greater effectiveness in the individual stages because the coalescence effect is able to manifest itself more.

The degree of effectiveness can be improved by additional characteristics that can be realized individually or cumulatively in the invention. Thus the pore size of the filtering means is reduced from stage to stage in a first embodiment. In addition, effectiveness can be improved in that the adsorption capacity of the filtering means increases in the individual stages from one stage to the next. This can be achieved through the filtering medium on basis of the characteristics of its material on the one hand, but also on the other hand on basis of an increasing layer thickness. The adsorption capacity of the filtering means can be adjusted through its impregnation. In order to collect as much moisture as possible in form of droplets in the first stage, the filter material should be as moisture repellent as possible in the first stage. This promotes the drip effect while the filtering means in the last stage should have as much as possible a suction effect.

As is known, the individual stages for the dripping moisture should be provided with a condensate run-off.

The invention is explained in further detail below through a drawing showing a multistage filter installation schematically.

The filter installation shown in the drawing consists of three identical stages 1, 2, 3. An additional, different stage 4 can be added downstream.

The first three stages 1, 2, 3 are provided with a formed fabric, a cloth or a foam material as the filtering means, while the last stage 4 contains active coal as the filtering means. The important point is that a coalescence effect should occur at the filtering means and that the collecting capacity of the filtering means which depends on the coalescence, the pore size, the thickness and other material and design characteristics increases from stage to stage. The filtering means may have a different structure. In particular, they may consist of a core and an outer foamed material or cloth envelope. The filtering means of the first stage 1 is heavily impregnated, so that moisture condensates because of coalescence, forms droplet pearls and can be removed over a condensate run-off 5, 6, 7.

The formed fabric or cloth of the second and third stage is gradually less impregnated, i.e. presenting more and more suction.

The flow velocity of the gaseous medium to be conveyed through the different stages 1 to 3 decreases from stage to stage without increase of pressure. This can be realized technically e.g. with suitable filtering means and their flow cross-section. This has a favorable effect on the effectiveness of the filter installation. In addition, the pore size of the filtering means can be reduced from stage to stage.

1. Multi-stage filter installation for media charged with water and/or oil, the stages (1, 2, 3) of which contain filtering means on which the water and/or the oil collected as a result of the coalescence effect, characterized in that the different stages (1-3) of the filter installation have an increasingly greater collection capacity in the direction of medium flow, so that the flow velocity is reduced from stage to stage without any increase in pressure.

2. Filter installation as in claim 1, characterized in that the pore size of the filtering means decreases from stage to stage.

3. Filter installation as in claim 1 or 2, characterized in that the adsorption capacity of the filtering means increases from stage to stage in the individual stages (1, 2, 3).

4. Filter installation as in one of the claims 1 to 3, characterized in that the layer thickness of the filtering means increases in the individual stages (1, 2, 3) from stage to stage.

5. Filter installation as in claim 3, characterized in that the adsorption capacity of the filtering means is adjusted by impregnation.
